(19) United States
(12) Patent Application Publication
(10) Pub. No.: US 2009/0023117 A1
(43) Pub. Date: Jan. 22, 2009

(54) Books of the bible

(76) Inventor: Donna Johnson, Jacksonville, NC (US)

Correspondence Address: DONNA JOHNSON, 349 W. CAROLE DRIVE, JACKSONVILLE, NC, 28546, US

(21) Appl. No.: 11/598,987

(22) Filed: Jul. 16, 2007

(51) Int. Cl. G09B 19/22; A63F 1/02

(52) U.S. Cl. 434/129; 273/299

(57) ABSTRACT

The Book of the Bible game effectively teaches the order of the books from Genesis to Revelation. The game consists of 66 cards (one-half inch). Game pieces will vary in languages, fonts, colors and logos (personal and authorized organizations). First Level: Cards are placed on a flat surface with the names of the bible facing upward. The player must arrange the cards in which he/she believes to be the correct order of the books of the bible. Accuracy is determined by the sequence of numbers. The player continues this level until it is mastered. Second Level: Cards are placed on a flat surface with the numbers facing upward in the correct number sequence 1-66. Beginning with the first book of the bible the player must say the name of the book aloud before turning over the card. The player continues this level until it is mastered.

### CROSS-REFERENCES

Not applicable

### FEDERALLY SPONSORED RESEARCH AND DEVELOPMENT

Not applicable

### COMPUTER PROGRAM

Not applicable

### BACKGROUND

The Books of the Bible is a game that teaches Christians the order of the books of the bible by name from the Old Testament to the New Testament. This invention relates to memory games and flash cards. The Books of the Bible game is offered as an educational tool for all ages, languages and levels of spirituality.

### DISCUSSION OF PRIOR ART

There are no current products or games on the market that adequately teaches the order of the books of the bible. Tabs are available to place at the beginning of each book however, this product enables a person's ability to learn the order of the books. It is a hindrance, not a teaching tool.

### ADVANTAGES

Accordingly, this invention has many advantages. The Books of the Bible game will surpass racial and denominational boundaries. The Books of the Bible will appeal to all Christians. This product can be produced in all languages and personalized (changeable logo). Rending the Books of the Bible game versatile and limitless.

### SUMMARY

According to the invention the game consists of 66 individual game pieces. Each game piece is approximately 3 inches (width)×1 inch (height) to be made of laminated card stock of various colors. Each game piece is double sided—the first side will consist of each name of the books in the bible (front view) and with the corresponding number centered on the back (rear view). Standard numbers apply, no roman numerals and the like will be utilized. Cards will be printed in sequence according to the bible table of contents. The game pieces will be printed in diverse languages, fonts, colors, with various graphics and logos.

### DESCRIPTION OF DRAWING

The drawings of the Books of the Bible are as follows:

FIG. 1—shows the front view of the double sided laminated card. The front view consist of the name of each book of the bible (on the right) and a graphic illustration (on the left); centered. The logo and the font of the name of the books may change per the request of the consumer.

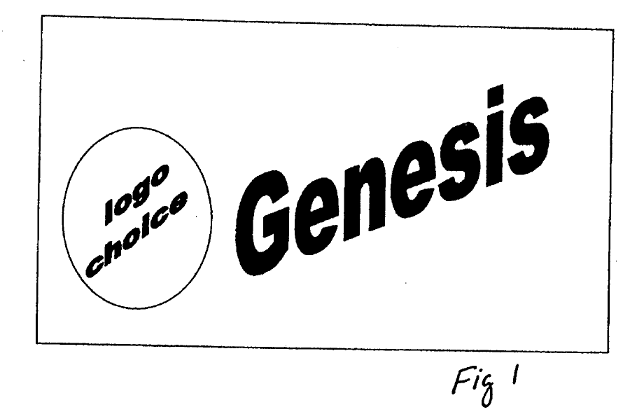

FIG. 2—shows the back view of the double sided laminated card. The back view will consist of the number corresponding with the correct sequence of the books of the bible from Genesis (1) to Revelation (66).

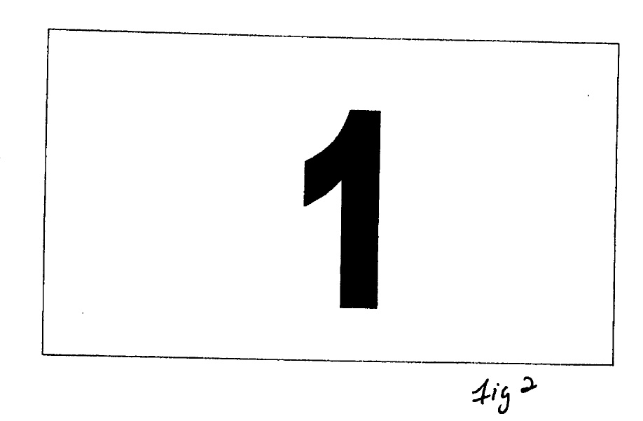

### DETAILED DESCRIPTION/OPERATION

The Books of the Bible has two levels of play, not limited to age or spiritual levels. First Level: All 66 game pieces are placed on a flat surface with the names of the bible facing upward (front view). The player must arrange the cards in which he or she believes to be the correct order of the books of the bible beginning with the Old Testament until what they believe to be the end of the New Testament. To check for accuracy the player turns all 66 of the game pieces to reveal the numerical side (rear view). The numerical side reveals to the player if he or she has placed the game pieces in the correct order. The player then reshuffles the cards with the front view facing upward until he or she has mastered this level. Second level: All 66 of the game pieces are placed on a flat surface with the numerical side facing upward (rear view) in sequence from 1 through 66. The player must say the name of the book aloud before turning over the game piece to reveal the correct name of the book (front view). The player continues this level until it is mastered. Therefore, challenging Christians of levels of spirituality, ages, languages and denominations.

### SEQUENCE LISTING

Not applicable.

1. A game utilized to teach the order of the books of the bible effectively. The games pieces consist of cards (about ½ or ⅓ the size of a standard business card). The games has two levels of play.
a. the game pieces will be printed in diverse languages
b. the game pieces will be printed on cardstock (or similar materials) available in diverse colors
c. the graphics on the game pieces will vary in color and fonts, with an option to personalize with initials, pictures, clipart and/or authorized organizational logos
